(19) United States
(12) Patent Application Publication
(10) Pub. No.: US 2023/0241926 A1
(43) Pub. Date: Aug. 3, 2023

(54) PNEUMATIC TIRE

(71) Applicant: The Yokohama Rubber Co., LTD., Tokyo (JP)

(72) Inventors: Toshiyuki IKEDA, Kanagawa (JP); Zenichiro SHIDA, Kanagawa (JP); Ryosuke NUKUSHINA, Kanagawa (JP)

(21) Appl. No.: 17/999,671

(22) PCT Filed: May 17, 2021
(86) PCT No.: PCT/JP2021/018546

§ 371 Date: Nov. 22, 2022

(30) Foreign Application Priority Data
May 28, 2020 (JP) 2020-093554

(51) Int. Cl. B60C 11/12

(52) U.S. Cl. CPC B60C 11/1236; B60C 11/1272; B60C 11/1259; B60C 2011/0348

(57) ABSTRACT

A pneumatic tire includes a shoulder land defined by a circumferential groove having a width of ≥3 mm on a tread and width-direction grooves in the shoulder land. The width-direction grooves include lug grooves having a width at a position at a center of the shoulder land in the width direction of ≥1.5 mm and a depth of ≥50% of a maximum depth of the width-direction grooves on a circumference. Blocks defined by the lug grooves have circumferential lengths varying at the position. A maximum-to-minimum ratio of circumferential lengths of the blocks is ≥1.2 and ≤1.8. The number of blocks on the circumference is N, the circumferential lengths of the blocks are sequentially P₁, P₂, . . . , P_{N}, the circumferential length of any block is Pᵢ (i=1 to N), the number of blocks satisfying Pᵢ/min(Pᵢ₋₁, Pᵢ₊₁)≤0.95 is M₁, the number of blocks satisfying 2Pᵢ/(Pᵢ₋₁+Pᵢ₊₁)≤0.95 is M₂, an index R satisfies 0≤R=((M₁·M₂)^{1/2}/N)≤0.2.

### TECHNICAL FIELD

The present technology relates to a pneumatic tire in which pitch variations are adopted in a tread pattern, and more specifically relates to a pneumatic tire that can provide a maintained effect of reducing “loudness” of pattern noise based on the pitch variations, reduced adjacent block integrated wear, and improved “abrasiveness” of the pattern noise.

### BACKGROUND ART

In a pneumatic tire for a passenger vehicle, pitch variations are adopted in a tread pattern in order to reduce the “loudness” of pattern noise (see, for example, Japan Unexamined Patent Publication Nos. H07-156615 A, H07-156614 A, H08-020205 A, H10-166817 A and 2015-120449 A). However, when pitch variations are adopted, although the effect of reducing the “loudness” is obtained with the frequency dispersion of the pattern noise, temporal variation occurs in noise due to block sizes varying on the tire circumference, causing “abrasiveness” to appear in the pattern noise. The “abrasiveness” is a state in which a rough, harsh and unpleasant tone is perceived instead of ear-pleasing and smooth sound.

On the other hand, in areas where a driving pattern with almost no acceleration or deceleration is frequently repeated, a special wear mode (hereinafter referred to as, “adjacent block integrated wear”) in which blocks adjacent in the tire circumferential direction wear in an integrated manner may occur in a shoulder portion on the inner side of a pneumatic tire when mounted on the vehicle. Such adjacent block integrated wear is mainly due to the difference in rigidity between the blocks adjacent in the tire circumferential direction.

### SUMMARY

The present technology provides a pneumatic tire that can provide maintained effect of reducing “loudness” of pattern noise based on pitch variations, reduced adjacent block integrated wear, and improved “abrasiveness” of the pattern noise.

A pneumatic tire according to an embodiment of the present technology includes a shoulder land portion defined by a circumferential groove having a groove width of 3 mm or more on a tread portion and a plurality of width direction grooves provided in the shoulder land portion and extending in a tire width direction. The width direction grooves include a plurality of lug grooves having a groove width at a reference position at a center of the shoulder land portion in the tire width direction of 1.5 mm or more and a groove depth of 50% or more of a maximum groove depth of the width direction grooves on a tire circumference. A plurality of block-like land portions defined by the lug grooves has circumferential lengths varying at the reference position. A ratio of a maximum to minimum circumferential length of the block-like land portions being in a range of 1.2 or more and 1.8 or less.

In the pneumatic tire, the number of block-like land portions on the tire circumference is N, the circumferential lengths of the block-like land portions are sequentially P₁, P₂, . . . , P_{N} along the tire circumferential direction, the circumferential length of any block-like land portion is Pᵢ (i=1 to N), the number of block-like land portions satisfying Pᵢ/min(Pᵢ₋₁, Pᵢ₊₁)≤0.95 is M₁, the number of block-like land portions satisfying 2Pᵢ/(Pᵢ₋₁+Pᵢ₊₁)≤0.95 is M₂, an index R is R=(M₁·M₂)^{1/2}/N, and the index R is in a range 0≤R≤0.2.

According to an embodiment of the present technology, in the pneumatic tire in which pitch variations are adopted in the shoulder land portion, the number of block-like land portions satisfying Pᵢ/min(Pᵢ₋₁, Pᵢ₊₁)≤0.95 is M₁, the number of block-like land portions satisfying 2Pᵢ/(Pᵢ₋₁+Pᵢ₊₁)≤0.95 is M₂, an index R is R=(M₁·M₂)^{1/2}/N, and the index R in a range 0≤R≤0.2 reduces adjacent block integrated wear while maintaining the effect of reducing the “loudness” of pattern noise based on the pitch variations and can improve the “abrasiveness” of pattern noise.

According to an embodiment of the present technology, it is preferable that the index R is in the range 0≤R≤0.2 at any position of a specified region of from 30% to 70% from an inner edge in the tire width direction toward a ground contact edge of the shoulder land portion. This effectively reduces adjacent block integrated wear and can improve the effect of improving the “abrasiveness” of pattern noise.

It is preferable that a ratio M₁/N of the number M₁ to the number N of the block-like land portions is in a range 0≤M₁/N≤0.15. This effectively reduces adjacent block integrated wear and can improve the effect of improving the “abrasiveness” of pattern noise.

It is preferable that the number of levels of the circumferential lengths of the block-like land portions is 3 or more, a maximum value of the circumferential length of the block-like land portions is Pₘₐₓ, a minimum value of the circumferential length of the block-like land portions is Pₘᵢₙ, a sum of circumferential lengths of block-like land portions satisfying Pᵢ<Pₘᵢₙ·(Pₘₐₓ/Pₘᵢₙ)^{1/3} is PL, a sum of circumferential lengths of block-like land portions satisfying Pᵢ>Pₘᵢₙ·(Pₘₐₓ/Pₘᵢₙ)^{2/3} is PH, the following Mathematical Formulas (1) and (2) are satisfied, and a relationship of 0.4≤PH/PL≤3.0 is satisfied.

$$0.2 \leq \frac{PL}{{\sum }_{i = 1}^{N} {P}_{i}} \leq 0.7 \qquad ( 1 )$$

$$0.2 \leq \frac{PH}{{\sum }_{i = 1}^{N} {P}_{i}} \leq 0.7 \qquad ( 2 )$$

This disperses the circumferential lengths of the block-like land portions so as not to be biased to a specific circumferential length, thus effectively reduces the “loudness” based on the pitch variations, and can enhance the effect of improving the “abrasiveness” of pattern noise.

It is preferable that narrow grooves having a groove width of 1 mm or more and 2 mm or less and a groove depth of 10% or more and less than 50% of the maximum depth of the lug grooves are disposed in the shoulder land portion at an angle of 35° or less with respect to the tire circumferential direction. Providing the narrow grooves oriented in the tire circumferential direction in this way reduces the rigidity of the shoulder land portion without adversely affecting the pattern noise and can further reduce the pattern noise.

It is preferable that at least one sipe which extends in the tire width direction and has a groove width of less than 1.5 mm and a groove depth of 50% or more and less than 100% of a maximum groove depth of the lug grooves is disposed in each of the block-like land portions of the shoulder land portion. Providing the sipes that have little effect on the pattern noise in this way reduces the rigidity of each of the block-like land portions of the shoulder land portion and can further reduce the pattern noise.

It is preferable that a ratio Pₘₐₓ/Pₘᵢₙ of the maximum value Pₘₐₓ to the minimum value Pₘᵢₙ of the circumferential lengths of the block-like land portions is 1.4 or more, and the number Mᵢ of sipes disposed in block-like land portions satisfying Pᵢ>Pₘᵢₙ·(Pₘₐₓ/Pₘᵢₙ)^{2/3} is larger than the number Mₘᵢₙ of sipes disposed in block-like land portions having the minimum value Pₘᵢₙ. Increasing the number of sipes in such block-like land portions having a large land portion length reduces the difference in rigidity between the block-like land portions and can effectively reduce the adjacent block integrated wear.

When mᵢ (mᵢ≥2) sipes are disposed in any block-like land portion crossing the reference position, the block-like land portion is partitioned into three or more small land portions by the mᵢ sipes, and circumferential lengths of the small land portions at the reference position are sequentially S₁, S₂, . . . , Sₘᵢ₊₁ along the tire circumferential direction, relationships min(S₁, Sₘᵢ₊₁)≥0.95·max(S₂, S₃, . . . Sₘ) and max(S₁, Sₘᵢ₊₁)≤1.5·min(S₂, S₃, . . . , Sₘᵢ) are preferably satisfied. Specifying the relationship between the circumferential lengths of the three or more small land portions defined in the block-like land portions in this way reduces the difference in rigidity between the small land portions, can effectively reduce the adjacent block integrated wear, and enhance the pattern noise reduction effect.

In an embodiment of the present technology, the reference position of the center of the shoulder land portion in the tire width direction is a position in the tire width direction that is a midpoint between the inner edge in the tire width direction and the ground contact edge of the shoulder land portion. However, when a circumferential groove with a groove width of less than 3 mm is at this position, the position is 5 mm away from the circumferential groove with a groove width of less than 3 mm to the outer side in the tire width direction. The ground contact edge of the tread portion is located at the outermost side in the tire axial direction of the ground contact shape measured under the condition that the tire is mounted on a regular rim, filled with regular internal pressure, placed vertically on a flat surface, and applied with a regular load. “Regular rim” refers to a rim defined by a standard for each tire according to a system of standards that includes standards with which tires comply, and is “standard rim” defined by Japan Automobile Tyre Manufacturers Association (JATMA), “Design Rim” defined by The Tire and Rim Association, Inc. (TRA), or “Measuring Rim” defined by European Tire and Rim Technical Organization (ETRTO), for example. “Regular internal pressure” is 230 kPa. “Regular load” is a load equivalent to 75% of the maximum load capacity determined for each tire by each standard in a standard system including the standard on which the tire is based.

### BRIEF DESCRIPTION OF DRAWINGS

FIG. 1 is a meridian cross-sectional view illustrating a pneumatic tire according to an embodiment of the present technology.

FIG. 2 is a developed view illustrating a tread pattern of the pneumatic tire of FIG. 1.

FIG. 3 is a plan view illustrating an enlarged main part of FIG. 2.

FIG. 4 is a cross-sectional view taken along the line IV-IV of FIG. 3.

FIG. 5 is a side view illustrating adjacent block integrated wear occurring in block-like land portions satisfying Pᵢ/min(Pᵢ₋₁, Pᵢ₊₁)≤0.95.

FIG. 6 is a side view illustrating adjacent block integrated wear occurring in block-like land portions satisfying 2P/(Pᵢ₋₁+Pᵢ₊₁)≤0.95.

FIG. 7 is a diagram illustrating the relationship between an index R and the ratio of abnormal wear occurrence sections.

FIG. 8 is a diagram illustrating the relationship between M₁/N and M₂/N and the abnormal wear occurrence state.

FIG. 9 is a diagram illustrating the arrangement of block-like land portions in test tires.

### DETAILED DESCRIPTION

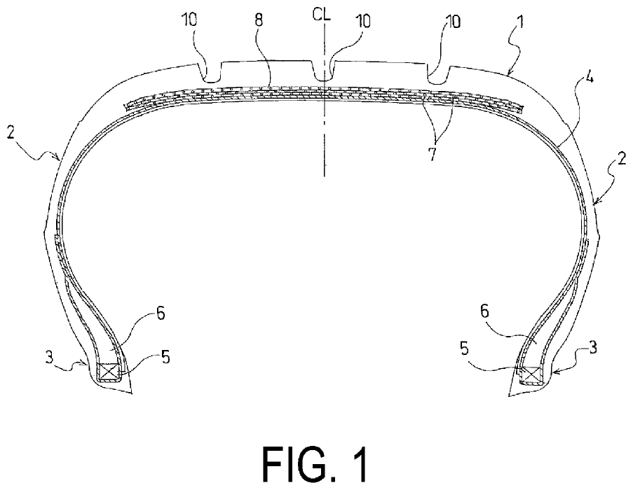

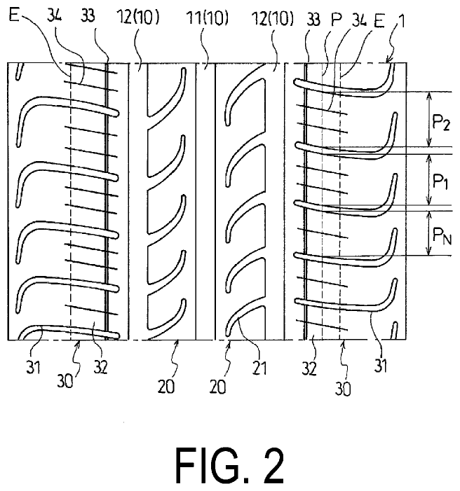

Configurations of embodiments of the present technology will be described in detail below with reference to the accompanying drawings. Note that the present technology is not limited to the following embodiments. Additionally, constituents of the embodiments include constituents that are substitutable and are obviously substitutes while maintaining consistency with the embodiments of the technology. Additionally, a plurality of modified examples described in the embodiments can be combined in a discretionary manner within the scope apparent to one skilled in the art. FIGS. 1 to 4 illustrate a pneumatic tire according to an embodiment of the present technology. In FIG. 1, CL is the tire center position. In FIG. 2, E is the ground contact edge.

As illustrated in FIG. 1, a pneumatic tire of the present embodiment includes an annular tread portion 1 extending in the tire circumferential direction, a pair of sidewall portions 2, 2 disposed on both sides of the tread portion 1, and a pair of bead portions 3, 3 disposed on an inner side of the sidewall portions 2 in the tire radial direction.

A carcass layer 4 is mounted between the pair of bead portions 3, 3. The carcass layer 4 includes a plurality of reinforcing cords extending in the tire radial direction and is folded back around a bead core 5 disposed in each of the bead portions 3 from a tire inner side to a tire outer side. A bead filler 6 having a triangular cross-sectional shape and formed of a rubber composition is disposed on the outer circumference of the bead core 5.

On the other hand, a plurality of belt layers 7 is embedded on an outer circumferential side of the carcass layer 4 in the tread portion 1. Each of the belt layers 7 includes a plurality of reinforcing cords that are inclined with respect to the tire circumferential direction, and the reinforcing cords are disposed so as to intersect each other between the layers. In the belt layers 7, the inclination angle of the reinforcing cords with respect to the tire circumferential direction is set to fall within a range of from 10° to 40°, for example. Steel cords are preferably used as the reinforcing cords of the belt layers 7. To improve high-speed durability, at least one belt cover layer 8, formed by disposing reinforcing cords at an angle of, for example, 5° or less with respect to the tire circumferential direction, is disposed on an outer circumferential side of the belt layers 7. Organic fiber cords such as nylon and aramid are preferably used as the reinforcing cords of the belt cover layer 8.

Note that the tire internal structure described above represents a typical example for a pneumatic tire, but the pneumatic tire is not limited thereto.

As illustrated in FIG. 2, a plurality of main grooves 10 extending in the tire circumferential direction is formed in the tread portion 1. The main groove 10 is a circumferential groove having a groove width of 3 mm or more, preferably 4 mm or more and 18 mm or less, and a groove depth of 5 mm or more and 11 mm or less. The main groove 10 includes a center main groove 11 located near the tire center position CL and a pair of shoulder main grooves 12, 12 located on the outermost side in the tire width direction. Thus, a pair of center land portions 20, 20 located between the shoulder main grooves 12, 12 and a pair of shoulder land portions 30, 30 located outside the shoulder main grooves 12, 12 are defined in the tread portion 1.

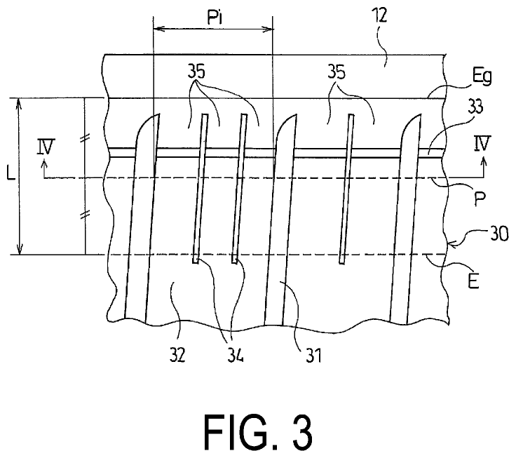

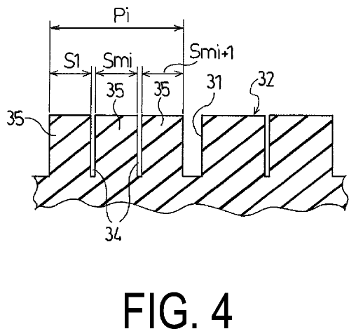

In each of the center land portions 20, a plurality of terminating grooves 21 having one end communicating with the shoulder main groove 12 and the other end terminating within the center land portion 20 is formed at intervals in the tire circumferential direction. On the other hand, as illustrated in FIGS. 3 and 4, in each of the shoulder land portions 30, a plurality of lug grooves 31 (width direction grooves) extending in the tire width direction without communicating with the shoulder main grooves 12 is formed at intervals in the tire circumferential direction.

Here, the position in the tire width direction, which is the midpoint between the inner edge Eg in the tire width direction and the ground contact edge E of the shoulder land portion 30, is defined as the reference position P of the center in the tire width direction of the shoulder land portion 30. When the position of the shoulder main groove 12 in the tire width direction varies along the tire circumferential direction, the inner edge Eg in the tire width direction of the shoulder land portion 30 is set to the position that protrudes most inward in the tire width direction. The lug grooves 31 have a groove width of 1.5 mm or more, preferably 3 mm or more and 6 mm or less, measured in the tire circumferential direction at the reference position P of the center of the shoulder land portion 12 in the tire width direction. The groove depth of the lug grooves 31 at the reference position P may vary along the tire circumferential direction, but in any case, the groove depth is 50% or more of the maximum depth of the width direction grooves extending in the tire width direction in the shoulder land portion 30 (the maximum depth of the lug grooves 31 in the embodiment illustrated in FIGS. 1 to 4). For example, the groove depth of the lug grooves 31 at the reference position P is preferably in the range of 2 mm or more and 6 mm or less or in the range of 30% or more and 80% or less of the main groove depth. A plurality of block-like land portions 32 is defined in the shoulder land portion 30 by the lug grooves 31 satisfying such dimensional requirements. The block-like land portion 32 may be completely divided by the lug grooves 31. Although the shoulder land portion 30 may have width direction grooves that do not satisfy the above-described dimensional requirements, they are not considered as lug grooves that define the block-like land portion 32.

The circumferential length Pᵢ of the block-like land portion 32 at the reference position P of the center of the shoulder land portion 30 in the tire width direction varies along the tire circumferential direction. The ratio of a maximum to minimum circumferential length Pᵢ of the block-like land portion 32 (the ratio of the maximum value P max to the minimum value Pₘᵢₙ) is set within the range of 1.2 or more and 1.8 or less. That is, pitch variations are applied to the block-like land portions 32 of the shoulder land portion 30.

In the pneumatic tire described above, when the number of block-like land portions 32 on the tire circumference is N, the circumferential lengths of the block-like land portions 32 are sequentially P₁, P₂, . . . , P_{N} along the tire circumferential direction, the circumferential length of any block-like land portion is Pᵢ (i=1 to N), the number of block-like land portions satisfying Pᵢ/min(Pᵢ₋₁Pᵢ₊₁)≤0.95 is M₁, the number of block-like land portions satisfying 2Pᵢ/(Pᵢ₋₁+Pᵢ₊₁)≤0.95 is M₂, and an index R is R=(M₁·M₂)^{1/2}/N, the index R is set in the range 0≤R≤0.2. Here, i−1=N when i=1, and i+1=1 when i=N.

The index R defined in this way can be controlled, for example, by adjusting the ratio of the circumferential lengths Pᵢ of adjacent block-like land portions 32, adjusting the number of levels of the circumferential lengths Pᵢ of the block-like land portions 32, or changing the arrangement of the block-like land portions 32.

In the pneumatic tire employing the pitch variations in the shoulder land portions 30 as described above, when the number of block-like land portions satisfying Pᵢ/min(Pᵢ₋₁, Pᵢ₊₁)≤0.95 is M₁, the number of block-like land portions satisfying 2Pᵢ/(Pᵢ₋₁+Pᵢ₊₁)≤0.95 is M₂, and the index R is R=(M₁·M₂)^{1/2}/N, the index R is in the range 0≤R≤0.2. As a result, it is possible to suppress adjacent block integrated wear while maintaining the effect of reducing the “loudness” of pattern noise based on pitch variations and improve “abrasiveness” of pattern noise.

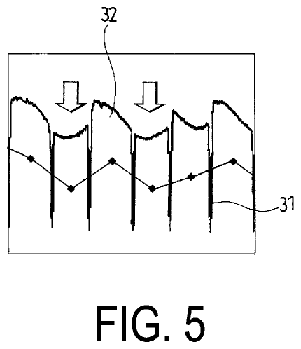

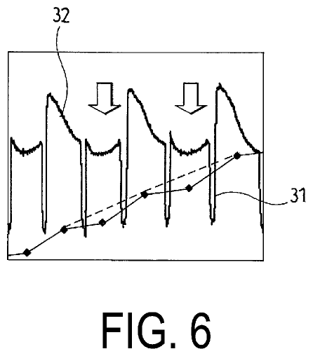

FIG. 5 illustrates the adjacent block integrated wear occurring in the block-like land portion 32 satisfying Pᵢ/min(Pᵢ₋₁, Pᵢ₊₁)≤0.95, and FIG. 6 illustrates the adjacent block integrated wear occurring in the block-like land portion 32 satisfying 2Pᵢ/(Pᵢ₋₁+Pᵢ₊₁)≤0.95. In FIGS. 5 and 6, the line graphs represent changes in the circumferential length of the block-like land portion in the tire circumferential direction.

According to the findings of the present inventors, as illustrated in FIG. 5, when Pᵢ/min(P₁₋₁, Pᵢ₊₁)≤0.95 is satisfied, and the circumferential length of any block-like land portion is significantly smaller than the minimum value of the circumferential lengths of both adjacent block-like land portions, a special wear mode (adjacent block integrated wear) is likely to occur in which the block-like land portions adjacent in the tire circumferential direction wear in an integrated manner. Further, as illustrated in FIG. 6, when 2Pᵢ/(Pᵢ₋₁+Pᵢ₊₁)≤0.95 is satisfied, and the circumferential length of any block-like land portion is significantly smaller than the average value of the circumferential lengths of both adjacent block-like land portions, a special wear mode (adjacent block integrated wear) is likely to occur in which the block-like land portions adjacent in the tire circumferential direction wear in an integral manner.

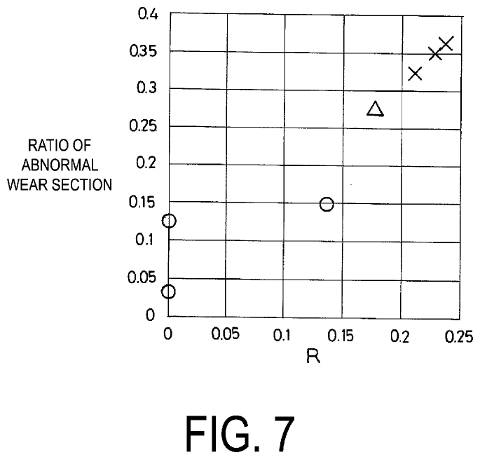

FIG. 7 illustrates the relationship between the index R and the ratio of abnormal wear occurrence sections. In FIG. 7, an example in which the ratio of abnormal wear occurrence sections is low is indicated by “∘”, an example in which the ratio of abnormal wear occurrence sections is high is indicated by “x”, and an example in which the ratio of abnormal wear occurrence sections is at an allowable level is indicated by “Δ”. As illustrated in FIG. 7, it can be understood that, by setting the index R in the range 0≤R≤0.2, the ratio of abnormal wear occurrence sections due to the adjacent block integrated wear is reduced. In particular, it is desirable that 0≤R≤0.16.

In particular, the index R may be in the range 0≤R≤0.2 at any position of a specified region of from 30% to 70% from the inner edge Eg in the tire width direction toward the ground contact edge E of the shoulder land portion 30 (that is, a belt-shaped region around the reference position P and having a width corresponding to 40% of the distance L from the inner edge Eg in the tire width direction to the ground contact edge E of the shoulder land portion 30). Satisfying 0≤R≤0.2 in a wide specified region including the reference position P in this way effectively reduces adjacent block integrated wear and can enhance the effect of improving the “abrasiveness” of the pattern noise.

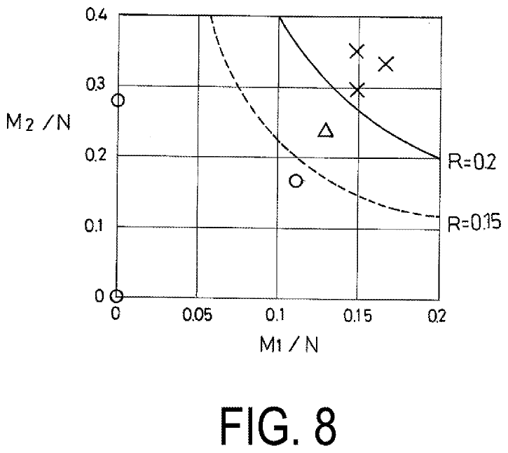

FIG. 8 illustrates the relationship between M₁/N, M₂/N, and the abnormal wear occurrence state. In FIG. 8, an example in which the ratio of abnormal wear occurrence sections is low is indicated by “∘”, an example in which the ratio of abnormal wear occurrence sections is high is indicated by “x”, and an example in which the ratio of abnormal wear occurrence sections is at an allowable level is indicated by “Δ”. As illustrated in FIG. 8, it is preferable that the ratio M₁/N of the number M₁ of block-like land portions 32 satisfying Pᵢ/min(Pᵢ₋₁, Pᵢ₊₁)≤0.95 to a total number N of block-like land portions 32 is in the range 0≤M₁/N≤0.15. Although the number M₁ of the sections where the change in the circumferential length Pᵢ of the block-like land portion 32 is large-small-large has a large effect on the “abrasiveness” of the pattern noise, it is possible to effectively suppress adjacent block integrated wear and enhance the effect of improving the “abrasiveness” of the pattern noise by lowering the ratio of the number M₁.

In the pneumatic tire described above, when the number of levels of the circumferential length of the block-like land portion 32 is 3 or more, a maximum value of the circumferential length of the block-like land portion 32 is Pₘₐₓ, a minimum value of the circumferential length of the block-like land portion 32 is Pₘᵢₙ, a sum of the circumferential lengths of the block-like land portions 32 satisfying Pᵢ<Pₘᵢₙ·(Pₘₐₓ/Pₘᵢₙ)^{1/3} is PL, and a sum of the circumferential lengths of the block-like land portions 32 satisfying Pᵢ>Pₘᵢₙ·(Pₘₐₓ/Pₘᵢₙ)^{2/3} is PH, the following expressions (1) and (2) may be satisfied and a relationship of 0.4≤PH/PL≤3.0 may be satisfied.

$$0.2 \leq \frac{PL}{{\sum }_{i = 1}^{N} {P}_{i}} \leq 0.7 \qquad ( 1 )$$

$$0.2 \leq \frac{PH}{{\sum }_{i = 1}^{N} {P}_{i}} \leq 0.7 \qquad ( 2 )$$

As a result, since the circumferential lengths of the block-like land portions 32 are dispersed and are not biased toward a specific circumferential length, it is possible to effectively reduce the “loudness” based on pitch variations and enhancing the effect of improving the “abrasiveness” of pattern noise.

Here, when the sum PL of the circumferential lengths of the block-like land portions 32 satisfying Pᵢ<Pₘᵢₙ·(Pₘₐₓ/Pₘᵢₙ)^{1/3} or the sum PH of the circumferential lengths of the block-like land portions 32 satisfying Pᵢ>Pₘᵢₙ·(Pₘₐₓ/Pₘᵢₙ)^{2/3} is too large or small for the whole, the circumferential length of the block-like land portions 32 will be biased and the effect of improving the “abrasiveness” of the pattern noise is reduced. Similarly, when the value of PH/PL is out of the above-described range, the circumferential length of the block-like land portion 32 is biased, and the effect of improving the “abrasiveness” of pattern noise is reduced. In particular, it is desirable to satisfy the relationship of 0.7≤PH/PL≤2.2.

In addition, when the number of levels of the circumferential length of the block-like land portion 32 is less than 3, the change in the circumferential length between levels becomes large, and the effect of improving adjacent block integrated wear and the “abrasiveness” of pattern noise is reduced. In particular, the number of levels of the circumferential lengths of the block-like land portions 32 is preferably 5 or more, and the upper limit thereof is preferably 40% or less of the number N of block-like land portions 32 on the tire circumference. Even the number of levels exceeding 40% of the number N has no difference in the effect.

In FIGS. 2 to 4, narrow grooves 33 having a groove width of 1 mm or more and 2 mm or less and a groove depth of 10% or more and less than 50% of the maximum depth of the lug grooves 31 are disposed in the shoulder land portion 30 at an angle of 35° or less with respect to the tire circumferential direction. Providing the narrow grooves 33 oriented in the tire circumferential direction in the shoulder land portion 30 in this manner reduces the rigidity of the shoulder land portion 30 without adversely affecting the pattern noise and can further reduce the pattern noise. Here, when the groove depth of the narrow groove 33 is too large, the effect of improving the adjacent block integrated wear is reduced due to an excessive decrease in rigidity. In addition, when the angle of the narrow groove 33 with respect to the tire circumferential direction is too large, the narrow groove 33 may cause pattern noise. The angle of the narrow groove 33 is the angle of a straight line connecting both ends of the narrow groove 33 with respect to the tire circumferential direction.

In FIGS. 2 to 4, at least one sipe 34 which extends in the tire width direction and has a groove width of less than 1.5 mm and a groove depth of 50% or more and less than 100% of the maximum groove depth of the lug grooves 31 is disposed in each block-like land portion 32 of the shoulder land portion 30. Providing the sipes 34 that have little effect on pattern noise in each block-like land portion 32 of the shoulder land portion 30 in this way reduces the rigidity of each block-like land portion 32 of the shoulder land portion and can further reduce the pattern noise.

The sipe 34 is preferably disposed such that a straight line connecting both ends thereof is at an angle of 30° or less with respect to the tire width direction. In this case, the rigidity in the front-rear direction of each block-like land portion 32 can be efficiently reduced. The sipe 34 is preferably disposed so that at least a portion of the sipe 34 overlaps a specified region of from 30% to 70% from the inner edge Eg in the tire width direction of the shoulder land portion 30 toward the ground contact edge E. More preferably, the sipe 34 is disposed crossing a position (the reference position P) of 50% from the inner edge Eg in the tire width direction toward the ground contact edge E of the shoulder land portion 30. Disposing the sipes 34 in this way reduces the rigidity near the center portion of each block-like land portion 32, thus efficiently reducing the rigidity of each block-like land portion 32 in the front-rear direction.

In addition, when the sipes 34 are disposed crossing the position (the reference position P) of 50% from the inner edge Eg in the tire width direction toward the ground contact edge E of the shoulder land portion 30, and each block-like land portion 32 is partitioned into a plurality of small land portions 35 by the sipes 34, the ratio of the larger one of the circumferential length of the small land portions 35 located at both ends in the tire circumferential direction of each block-like land portion 32 to the smaller one of the circumferential length is preferably 1.2 or less. As a result, the rigidity on the leading side and the trailing side when each block-like land portion 32 contacts the ground during rolling of the tire is balanced and the adjacent block integrated wear can be effectively suppressed.

In the above-described pneumatic tire, it is preferable that the ratio Pₘₐₓ/Pₘᵢₙ of the maximum value Pₘₐₓ to the minimum value Pₘᵢₙ of the circumferential length of the block-like land portion 32 is 1.4 or more, and the number Mᵢ of sipes 34 disposed in the block-like land portion 32 satisfying Pᵢ>Pₘᵢₙ·(Pₘₐₓ/Pₘᵢₙ)^{2/3} is larger than the number Mₘᵢₙ of sipes 34 disposed in the block-like land portion 32 having the minimum value Pₘᵢₙ. Increasing the number of sipes 34 in such a block-like land portion 32 having a relatively large land portion length reduces the difference in rigidity between the block-like land portions 32 and can effectively reduce the adjacent block integrated wear. However, when the difference in the number of sipes 34 between the block-like land portions 32 is too large, a difference in rigidity will occur. Thus, the upper limit of the number Mᵢ of sipes 34 is preferably set to Mₘᵢₙ·(Pₘₐₓ/Pₘᵢₙ)+1.

In the above-described pneumatic tire, it is preferable that when mᵢ (mᵢ≥2) sipes are disposed in any block-like land portion 32 crossing the reference position P, the block-like land portion 32 is partitioned into three or more small land portions 35 by the mᵢ sipes, and the circumferential lengths of the small land portions 35 at the reference position P are sequentially S₁, S₂, . . . , Sₘᵢ₊₁ along the tire circumferential direction, a relationship of min(S₁, Sₘᵢ₊₁)≥0.95·max(S₂, S₃, . . . Sₘ) and max(S₁, Sₘᵢ₊₁)≤1.5·min(S₂, S₃, . . . Sₘᵢ) is satisfied.

Specifying the relationship of the circumferential lengths of the three or more small land portions 35 defined in the block-like land portion 32 in this way reduces the difference in rigidity between the small land portions 35, can effectively reduce the adjacent block integrated wear, and enhance the pattern noise reduction effect. Here, when the minimum value of the circumferential lengths S₁, Sₘᵢ₊₁ of the small land portions 35 located at both ends in the tire circumferential direction of the block-like land portion 32 is smaller than 0.95 times the maximum value of the circumferential lengths S₂, S₃, . . . , Sₘ of the other small land portions 35, the difference in rigidity between the small land portions 35 becomes excessive and the desired effect cannot be obtained. In addition, when the minimum value of the circumferential lengths (S₁, Sₘᵢ₊₁) of the small land portions 35 located at both ends in the tire circumferential direction of the block-like land portion 32 is larger than 1.5 times the maximum value of the circumferential lengths (S₂, S₃, . . . , Sₘ) of the other small land portions 35, the difference in rigidity between the small land portions 35 becomes excessive and the desired effect cannot be obtained.

A pitch variation that satisfies the specific requirements described above can be applied to at least one shoulder land portion of a pneumatic tire and may be applied to both shoulder land portions. Further, in a pneumatic tire having a specified mounting direction with respect to a vehicle, it is preferable to apply a pitch variation that satisfies the above-described specific requirements to the shoulder land portion on the vehicle mounting inner side.

### Example

Pneumatic tires of Conventional Example and Examples 1 to 11 were manufactured. The tires have a size of 225/55R17, and include a tread portion provided with a shoulder land portion defined by a circumferential groove having a groove width of 3 mm or more, the shoulder land portion includes a plurality of width direction grooves extending in a tire width direction, the width direction grooves include a plurality of lug grooves having a groove width at a reference position at a center of the shoulder land portion in the tire width direction of 1.5 mm or more and a groove depth of 50% or more of a maximum groove depth of the width direction grooves on a tire circumference, and a pitch variation is employed in which a plurality of block-like land portions defined by the lug grooves has circumferential lengths varying at the reference position. In the tires, the number N of block-like land portions on the tire circumference is 54, the number of levels of the circumferential lengths of the block-like land portions is 7, the ratio Pₘₐₓ/Pₘᵢₙ of the maximum value Pₘₐₓ to the minimum value Pₘᵢₙ of the circumferential lengths of the block-like land portions is 1.5, and the other configurations are set as illustrated in Table 1.

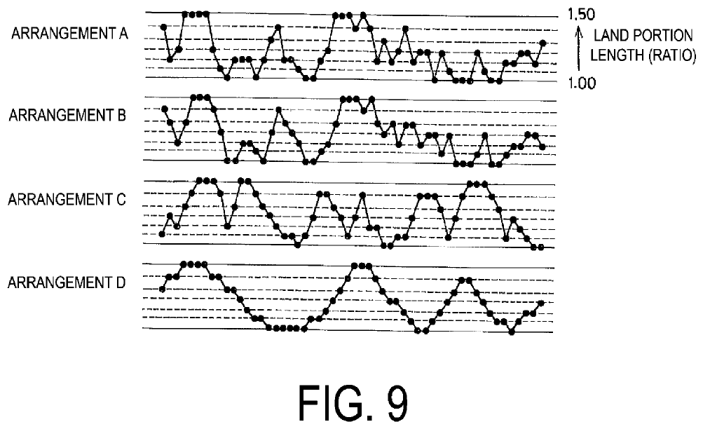

As the arrangement of the block-like land portions, one of A to D illustrated in FIG. 9 was adopted. As the type of level of the circumferential length of the block-like land portion, the following type X (equal difference) or type Y (equal ratio) was adopted.

### Type X: 1.00, 1.08, 1.17, 1.25, 1.33, 1.42, 1.5

### Type Y: 1.00, 1.07, 1.14, 1.22, 1.31, 1.40, 1.5

Furthermore, in Conventional Example and Examples 1 to 11, the index R at the reference position, the maximum value of the index R in the specified region, M₁/N, PH/PL, the presence of narrow grooves, the number of sipes in a small block-like land portion, the number of sipes in a large block-like land portion, and the ratio of the circumferential length of small land portions located at both ends in the tire circumferential direction of the block-like land portion to the circumferential length of the small land portion located in an intermediate portion in the tire circumferential direction of the block-like land portion were varied. In Conventional Example and Example 1, the angle of the lug grooves is changed according to the circumferential length of the block-like land portion. In Examples 2 to 11, the angle of the lug grooves was constant regardless of changes in the circumferential length of the block-like land portions.

These test tires were evaluated for uneven wear resistance and pattern noise performance by the following test methods, and the results are also shown in Table 1.

Uneven Wear Resistance:

Each test tire was assembled on a wheel with a rim size of 17×7.5J, mounted on a front wheel drive vehicle with an engine displacement of 2 liters, and inflated to an air pressure of 220 kPa. After running 20,000 km on a dry road surface, a circumferential profile of the shoulder land portion on the vehicle mounting inner side of each of the four wheels was measured at the reference position. The number of sections where adjacent block integrated wear occurred was counted, and a total number for four wheels was obtained. The evaluation results are expressed as index values using the reciprocal of the total number of wear occurrence sections with the value of Conventional Example being defined as 100. Larger index values indicate the smaller number of sections where adjacent block integrated wear occurred and superior uneven wear resistance.

Pattern Noise Performance:

Each test tire was assembled on a wheel with a rim size of 17×7.5J, mounted on a front wheel drive vehicle with an engine displacement of 2 liters, and inflated to an air pressure of 220 kPa. Feeling evaluation was conducted for the “loudness” and the “abrasiveness” with regard to noise (pattern noise) in the cabin when running on a dry and smooth asphalt road surface at a speed of 60 km/h. The evaluation results were scored with index values with the value of Conventional Example being defined as 100. Larger index values indicate superior pattern noise performance.

TABLE 1

| | Conven- | | | |
|---|---|---|---|---|
| | tional | Example | Example | Example |
| | Example | 1 | 2 | 3 |
| Arrangement of block- | A | B | B | C |
| like land portions | | | | |
| Circumferential length | X | X | X | X |
| level type | | | | |
| Index R at reference | 0.22 | 0.19 | 0.19 | 0.15 |
| position | | | | |
| Maximum value of index | 0.25 | 0.21 | 0.19 | 0.15 |
| R in specified region | | | | |
| M₁/N | 0.17 | 0.17 | 0.15 | 0.13 |
| PH/PL | 3.63 | 2.77 | 2.77 | 3.32 |
| Presence of narrow | No | No | No | No |
| groove | | | | |
| Number of sipes in small | 0 | 0 | 0 | 0 |
| block-like land portion | | | | |
| Number of sipes in large | 0 | 0 | 0 | 0 |
| block-like land portion | | | | |
| Circumferential length | — | — | — | — |
| ratio of small land | | | | |
| portion | | | | |
| Uneven wear resistance | 100 | 120 | 130 | 130 |
| Pattern noise | 100 | 100 | 100 | 100 |
| performance “loudness” | | | | |
| Pattern noise | 100 | 105 | 110 | 115 |
| performance | | | | |
| “abrasiveness” | | | | |
| | Example | Example | Example | Example |
| | 4 | 5 | 6 | 7 |
| Arrangement of block- | C | C | C | C |
| like land portions | | | | |
| Circumferential length | Y | Y | Y | Y |
| level type | | | | |
| Index R at reference | 0.15 | 0.15 | 0.15 | 0.15 |
| position | | | | |
| Maximum value of index | 0.15 | 0.15 | 0.15 | 0.15 |
| R in specified region | | | | |
| M₁/N | 0.13 | 0.13 | 0.13 | 0.13 |
| PH/PL | 1.99 | 1.99 | 1.99 | 1.99 |
| Presence of narrow | No | Yes | Yes | Yes |
| groove | | | | |
| Number of sipes in small | 0 | 0 | 1 | 1 |
| block-like land portion | | | | |
| Number of sipes in large | 0 | 0 | 1 | 2 |
| block-like land portion | | | | |
| Circumferential length | — | — | — | 1.70 |
| ratio of small land | | | | |
| portion | | | | |
| Uneven wear resistance | 130 | 130 | 130 | 135 |
| Pattern noise | 105 | 110 | 115 | 120 |
| performance “loudness” | | | | |
| Pattern noise | 120 | 125 | 130 | 135 |
| performance | | | | |
| “abrasiveness” | | | | |
| | Example | Example | Example | Example |
| | 8 | 9 | 10 | 11 |
| Arrangement of block- | C | C | C | D |
| like land portions | | | | |
| Circumferential length | Y | Y | Y | Y |
| level type | | | | |
| Index R at reference | 0.15 | 0.15 | 0.15 | 0.02 |
| position | | | | |
| Maximum value of index | 0.15 | 0.15 | 0.15 | 0.02 |
| R in specified region | | | | |
| M₁/N | 0.13 | 0.13 | 0.13 | 0.02 |
| PH/PL | 1.99 | 1.99 | 1.99 | 0.82 |
| Presence of narrow | Yes | Yes | Yes | Yes |
| groove | | | | |
| Number of sipes in small | 1 | 1 | 1 | 1 |
| block-like land portion | | | | |
| Number of sipes in large | 2 | 2 | 2 | 2 |
| block-like land portion | | | | |
| Circumferential length | 0.80 | 1.40 | 0.95 | 1.00 |
| ratio of small land | | | | |
| portion | | | | |
| Uneven wear resistance | 135 | 140 | 140 | 150 |
| Pattern noise | 120 | 125 | 125 | 125 |
| performance “loudness” | | | | |
| Pattern noise | 135 | 140 | 140 | 150 |
| performance | | | | |
| “abrasiveness” | | | | |

As can be seen from Table 1, the tires of Examples 1 to 11 could suppress adjacent block integrated wear while maintaining the effect of reducing the “loudness” of pattern noise based on pitch variations and improve “abrasiveness” of pattern noise.

1. A pneumatic tire, comprising:
a shoulder land portion defined by a circumferential groove having a groove width of 3 mm or more on a tread portion; and
a plurality of width direction grooves provided in the shoulder land portion and extending in a tire width direction;
the width direction grooves comprising a plurality of lug grooves having a groove width at a reference position at a center of the shoulder land portion in the tire width direction of 1.5 mm or more and a groove depth of 50% or more of a maximum groove depth of the width direction grooves on a tire circumference,
a plurality of block-like land portions defined by the lug grooves having circumferential lengths varying at the reference position,
a ratio of a maximum to minimum circumferential length of the block-like land portions being in a range of 1.2 or more and 1.8 or less,
the number of block-like land portions on the tire circumference being N, the circumferential lengths of the block-like land portions being sequentially P₁, P₂, . . . , P_{N} along the tire circumferential direction,
the circumferential length of any block-like land portion being Pᵢ (i=1 to N),
the number of block-like land portions satisfying Pᵢ/min(Pᵢ₋₁, Pᵢ₊₁)≤0.95 being M₁,
the number of block-like land portions satisfying 2Pᵢ/(Pᵢ₋₁, Pᵢ₊₁)≤0.95 being M₂,
an index R being R=(M₁·M₂)^{1/2}/N, and
the index R being in a range 0≤R≤0.2.

2. The pneumatic tire according to claim 1, wherein the index R is also in the range 0≤R≤0.2 at any position of a specified region of from 30% to 70% from an inner edge in the tire width direction toward a ground contact edge of the shoulder land portion.

3. The pneumatic tire according to claim 1, wherein a ratio M₁/N of the number M₁ to the number N of the block-like land portions is in a range 0≤M₁/N≤0.15.

4. The pneumatic tire according to claim 1, wherein
the number of levels of the circumferential lengths of the block-like land portions is 3 or more,
a maximum value of the circumferential length of the block-like land portions is Pₘₐₓ,
a minimum value of the circumferential length of the block-like land portions is Pₘᵢₙ,
a sum of circumferential lengths of block-like land portions satisfying Pᵢ<Pₘᵢₙ·(Pₘₐₓ/Pₘᵢₙ)^{1/3} is PL,
a sum of circumferential lengths of block-like land portions satisfying Pᵢ>Pₘᵢₙ·(Pₘₐₓ/Pₘᵢₙ)^{2/3} is PH,
Mathematical Formulas (1) and (2)
$$0.2 \leq \frac{PL}{{\sum }_{i = 1}^{N} {P}_{i}} \leq 0.7 \qquad ( 1 )$$
$$0.2 \leq \frac{PH}{{\sum }_{i = 1}^{N} {P}_{i}} \leq 0.7 \qquad ( 2 )$$
are satisfied, and
a relationship of 0.4≤PH/PL≤3.0 is satisfied.

5. The pneumatic tire according to claim 1, wherein
narrow grooves having a groove width of 1 mm or more and 2 mm or less and a groove depth of 10% or more and less than 50% of the maximum groove depth of the lug grooves are disposed in the shoulder land portion at an angle of 35° or less with respect to the tire circumferential direction.

6. The pneumatic tire according to claim 1, wherein
at least one sipe which extends in the tire width direction and has a groove width of less than 1.5 mm and a groove depth of 50% or more and less than 100% of a maximum depth of the lug grooves is disposed in each of the block-like land portions of the shoulder land portion.

7. The pneumatic tire according to claim 6, wherein
a ratio Pₘₐₓ/Pₘᵢₙ of the maximum value Pₘₐₓ to the minimum value Pₘᵢₙ of the circumferential lengths of the block-like land portions is 1.4 or more, and
the number Mᵢ of sipes disposed in the block-like land portions satisfying Pᵢ>Pₘᵢₙ·(Pₘₐₓ/Pₘᵢₙ)^{2/3} is larger than the number Mₘᵢₙ of sipes disposed in the block-like land portions having the minimum value Pₘᵢₙ.

8. The pneumatic tire according to claim 6, wherein
mᵢ (mᵢ≥2) sipes are disposed in any block-like land portions crossing the reference position,
the block-like land portions are partitioned into three or more small land portions by the mᵢ sipes,
circumferential lengths of the small land portions at the reference position are sequentially S₁, S₂, . . . , Sₘᵢ₊₁ along the tire circumferential direction, and
relationships min(S₁, Sₘᵢ₊₁)≥0.95·max(S₂, S₃, . . . Sₘ) and max(S₁, Sₘᵢ₊₁)≤1.5·min(S₂, S₃, . . . , Sₘᵢ) are satisfied.

9. The pneumatic tire according to claim 2, wherein
the number of levels of the circumferential lengths of the block-like land portions is 3 or more,
a maximum value of the circumferential length of the block-like land portions is Pₘₐₓ,
a minimum value of the circumferential length of the block-like land portions is Pₘᵢₙ,
a sum of circumferential lengths of block-like land portions satisfying Pᵢ<Pₘᵢₙ·(Pₘₐₓ/Pₘᵢₙ)^{1/3} is PL,
a sum of circumferential lengths of block-like land portions satisfying Pᵢ>Pₘᵢₙ·(Pₘₐₓ/Pₘᵢₙ)^{2/3} is PH,
$$\begin{matrix}Mathematical Formulas ( 1 ) and ( 2 ) & \\ 0.2 \leq \frac{PL}{{\sum }_{i = 1}^{N} {P}_{i}} \leq 0.7 & ( 1 )\end{matrix}$$
$$0.2 \leq \frac{PH}{{\sum }_{i = 1}^{N} {P}_{i}} \leq 0.7 \qquad ( 2 )$$
are satisfied, and
a relationship of 0.4≤PH/PL≤3.0 is satisfied.

10. The pneumatic tire according to claim 9, wherein
narrow grooves having a groove width of 1 mm or more and 2 mm or less and a groove depth of 10% or more and less than 50% of the maximum groove depth of the lug grooves are disposed in the shoulder land portion at an angle of 35° or less with respect to the tire circumferential direction.

11. The pneumatic tire according to claim 10, wherein
at least one sipe which extends in the tire width direction and has a groove width of less than 1.5 mm and a groove depth of 50% or more and less than 100% of a maximum depth of the lug grooves is disposed in each of the block-like land portions of the shoulder land portion.

12. The pneumatic tire according to claim 11, wherein
a ratio Pₘₐₓ/Pₘᵢₙ of the maximum value Pₘₐₓ to the minimum value Pₘᵢₙ of the circumferential lengths of the block-like land portions is 1.4 or more, and
the number Mᵢ of sipes disposed in the block-like land portions satisfying Pᵢ>Pₘᵢₙ·(Pₘₐₓ/Pₘᵢₙ)^{2/3} is larger than the number Mₘᵢₙ of sipes disposed in the block-like land portions having the minimum value Pₘᵢₙ.

13. The pneumatic tire according to claim 12, wherein
mᵢ (mᵢ≥2) sipes are disposed in any block-like land portions crossing the reference position,
the block-like land portions are partitioned into three or more small land portions by the mᵢ sipes,
circumferential lengths of the small land portions at the reference position are sequentially S₁, S₂, . . . , Sₘᵢ₊₁ along the tire circumferential direction, and relationships min(S₁, Sₘᵢ₊₁)≥0.95·max(S₂, S₃, . . . Sₘ) and max(S₁, Sₘᵢ₊₁)≤1.5·min(S₂, S₃, . . . , Sₘᵢ) are satisfied.
